(19) United States
(12) Patent Application Publication
(10) Pub. No.: US 2005/0184855 A1
(43) Pub. Date: Aug. 25, 2005

(54) Fingerprint vehicle access system

(76) Inventor: Robert Lee Burchette JR., Chesnee, SC (US)

Correspondence Address: John B. Hardaway, III;NEXSEN PRUET, LLC, P.O. Box 10107, Greenville, SC, 29603, US

(21) Appl. No.: 10/785,214

(22) Filed: Feb. 24, 2004

(51) Int. Cl. G06T 1/00; G05B 19/00

(52) U.S. Cl. 340/5.53; 340/5.72

(57) ABSTRACT

A device and method for accessing a vehicle having electrically or electronically activated door locks using a fingerprint sensor to detect persons having rights of entry. The device includes means to selectively open doors, trunks, etc., using different fingers and is used in conjunction with an existing access control and alarm system.

### BACKGROUND OF THE INVENTION

1. Field of the Invention

This invention relates to security control for a motorized vehicle having electrically or electronically activated door locks using fingerprint identification for access control and security.

2. Background and Prior Art

One or more keys have been used for entry control to houses, cars, businesses and other secure areas for decades. A key in mechanical or electronic form is the standard method for accessing a motorized vehicle or boat. Keys have a degree of uniqueness but are readily duplicated and frequently are lost, mislaid, stolen or damaged. Often, due to the convenience of locking car doors without a key, they are left inside a locked car.

Fingerprints have been used for personal identification since they were introduced in 1903 in the New York State prison system. The presumption that each fingerprint set is unique to an individual is generally accepted as fact. Within recent years it has become possible to read fingerprints electronically and store the information in a digital library. Biometric systems based upon the physical identification of personal characteristics, including fingerprints, have been developed since 1980 for security control primarily in the field of computer security. Representative fingerprint identification systems include United Stated published patent application 20020031244, U.S. Pat. No. 6,327,376 and U.S. Pat. No. 6,320,974, U.S. Pat. No. 6,317,508, U.S. Pat. No. 6,282,304, U.S. Pat. No. 6,181,807, U.S. Pat. No. 6,178,255, U.S. Pat. No. 6,185,316 and U.S. Pat. No. 5,974,162. Representative applications of fingerprint recognition include U.S. Pat. No. 6,111,977 to Scott et al. which is directed to a portable recognition transmitter which serves as an electronic key in the manner of a cordless remote control, and U.S. Pat. No. 6,078,265 to Bonder et al which employs an intelligent mechanical key having a fingerprint scanning chip embedded in the surface of the key. Bonder is described as being useful in an automotive ignition interlock.

U.S. Pat. Nos. 6,260,300 and 6, 357,156 to Klebes et al. are directed to fingerprint activated lock and enablement systems to safekeep and actuate electronic firearms.

U.S. Pat. No. 6,225,890 to Murphy is directed to a system employing biometric indicia, including fingerprints, to restrict access to or use of a motorized vehicle in a manner similar to an electronic handcuff.

U.S. Pat. No. 6,100,811 to Hsu et al. is directed to a system to control access to and operation of a vehicle using a fingerprint sensor inside the care and optionally, a second sensor in the door handle.

U.S. Pat. No. 6,272,745 to Anzai et al. is directed to an authorization system for controlling access to various vehicle functions based upon prior enrollment of a fingerprint.

U.S. Pat. No. 6,374,652 to Hwang is directed to a locking doorknob which recognizes fingerprints.

There remains a need for a simple access control system which can be easily installed on a vehicle and which can be easily programmed for a variety of users and for a variety of control functions.

### BRIEF DESCRIPTION OF THE INVENTION

It is a first objective of this invention to provide a security system for a motorized vehicle which screens access on the basis of one or more authorized fingerprints. It is a further objective of this invention to provide a security system for a motorized vehicle which allows selective operation of vehicle functions such as opening of one door, more than one door, or a trunk. It is yet a further objective of this invention to provide a fingerprint-based security system which simultaneously or alternatively controls an alarm system and/or a starter motor interlock installed on the motorized vehicle. It is an additional objective to provide a fingerprint-based security system which can lock vehicle doors and activate alarms and other security systems. It is yet a further objective of this invention to provide a fingerprint actuated security system which can be installed on any vehicle having electric door locks and which may be installed as either an OEM or an aftermarket device. It is yet another objective to provide a system which allows enrollment in the system remotely.

These and other objectives of this invention may be accomplished using a module having an external fingerprint reader and/or a programmed access chip and an electronic circuit including a programmable microchip, power source, switching devices and connectors to other on-car functions. The objectives may also be accomplished through the addition of a sleep circuit and a wakeup switch means for indicating the status of the device and means for controlling more than one lock or one or more security functions. Objectives may also be achieved by a system having multiple readers and a central or distributed control circuit. The objectives may also be met by a security device further incorporating a proximity switch. The system may be the sole means of access or an alternative means.

### BRIEF DESCRIPTION OF THE DRAWINGS

FIG. 1 is a perspective view of an opened face of a first embodiment of the access device.

FIG. 1A is a perspective view of an opened face of a second embodiment of the access device.

FIG. 2 is a schematic showing the components of a motherboard for the device.

FIG. 3A is a flow diagram of the operation of the device in a first embodiment.

FIG. 3B is a flow diagram of the operation of the device in a second embodiment.

FIG. 4 shows a plan view of an enroller for the device.

### DETAILED DESCRIPTION OF THE INVENTION

The access control device according to this invention is applicable to any motorized vehicle including automobiles, trucks, buses, motor boats or any other similar device which has an electrically or electronically actuated system for opening doors, trunks, and other entry means, and for activating and deactivating ignition interlocks, alarms and other security functions. The so-called “keyless entry” access control system has been commonplace on motorized vehicles and uses an acoustical system to activate solenoids controlling the position of door locks and to engage and disengage alarms and interlocks. The access control device of this invention is specifically intended to work with such an existing system, although vehicles lacking such a system may be modified for this invention.

The electronic fingertip access control device, according to this invention, consists of an external housing bearing an electronic fingerprint sensor under a protective cover or cap and a black box preferably mounted in the interior of the vehicle. The sensor housing may be mounted in an exposed or accessible portion of a vehicle so that it may be readily accessed by an authorized person seeking entry to the vehicle. Representative locations include the base of the windscreen, the base of a rear window or any other location expected to be protected from impact from road debris and other damaging contact.

The external housing base contains an electronic fingerprint sensor, an on-off switch, and one or more plug connections for communication cables. A cover protects the face of the sensor from damage and soiling and preferably is part of the switching means when used to activate the system. When used to activate the system, the switching means may be electromechanical but for reliability, a reed switch in the base activated by a magnet fixed in the cover is preferred. Other switching means include heat sensors under the cover and proximity sensors. A small light such as a light emitting diode (LED) is mounted near the fingerprint sensor to indicate the status of the system. The base is sealed to prevent entry of water and dust. For most applications the sensor housing is successfully mounted with two-way tape but other mounting systems such as screws and rivets are contemplated.

Alternatively, the system may be awakened by pushing a membrane button on the covered surface of the housing. In either configuration, the use of a wake-up system conserves electricity and the lifetime of the electronic components, especially during extended periods of non-use.

An electronic “black box” is mounted preferably within the vehicle in a protected location. For most automotive applications, the box is mounted under the dashboard for ease of access to the existing wiring harness. The box contains a circuit board with at least one computer chip, means for connecting to the fingerprint sensor and to a power supply and for signaling the components being activated. Relays to connect power to the signaled wire are also mounted on the board and connected to plugin connectors for wiring to the harness or component.

Power to signal door opening devices, which are usually solenoids, may be drawn from the vehicle fuse box which typically is mounted within the passenger compartment and usually under the dashboard. Engine interlock and alarm systems are disabled according to their originally installed circuit layout and are typically linked to the door-lock operating system so that they may be selected along with a door by a single signal.

Power for the computer chip(s) may be stepped down on the board using a transformer or may be separately sourced from a separate battery which may be rechargeable. Contemporary electrical systems have been standardized for many years at a nominal 12 volts and the voltage through the relays is expected to remain so for several years. At such time as the standard changes to 24 v (or higher), the system described above is readily adapted to maintain on-board operations to a lower voltage while up-rating the servo voltage. The back-up battery may be replaced by one having additional amperage or capacity, as will be discussed below.

The access system of this invention is intended to be used in connection with an existing “electronic key” system using ultrasonic signals and is an alternative or back-up to that system which does not disable the existing entry system. Typically, one fingerprint sensor is used per vehicle. However, multiple external sensors may be used and wired to the control “black box.” Just as it is necessary to program the existing electronic key for each vehicle, it is necessary also to program the electronic fingertip access system to the user. This may be done by connecting the system to a computer using a standard serial port on the control “black box. To enroll a user on the basis of an electronic image of a fingerprint (fingerprint identification), the user would place a finger on the fingerprint sensor and the print would be identified with a function, such as “open trunk”, on the computer screen. Different fingers may be designated for different functions. The fingers of both hands may be “paralleled” so that if the fingers of one hand are not available due to injury, the same access is provided using the other hand. Additional uses can be enrolled at the same time or a different time and earlier enrolled users can be deleted as when the vehicle is sold or a user deleted for any other reason. In the preferred embodiment, the prints are verified during enrollment.

The enrollment process may be done by anyone with a PC or PDA. For security purposes, it is intended that enrollment be done only by a dealership or the authorized installer and the enrollment program password protected. Also for security, the data stored are in such form and specificity that the data cannot be used as a source of latent prints in the event that the data on the chip is “hacked.”

In a preferred alternative, a separate enrolling device in the form of a small, hand-held dumb terminal which connects to the black box by a simple connections such as an RJ25 telephone cord and which is powered by the power source in the black box. Such an enroller is password protected and allows both enrollment of individuals, typically validating two fingers and also displays diagnostic functions in the event of a malfunction and enables other changes to accommodate different settings in relay speeds and other electronics functions characteristic of different car electronic systems. The enroller is also used to enroll new users and disable old users at the time of sale.

The data from enrollment is stored in a chip in the fingerprint sensor housing but more desirably on the motherboard of the “black box” in a look-up copy. The operation of the relays may be controlled from the same or a different chip from the enrollment function to simplify design and reduce cost.

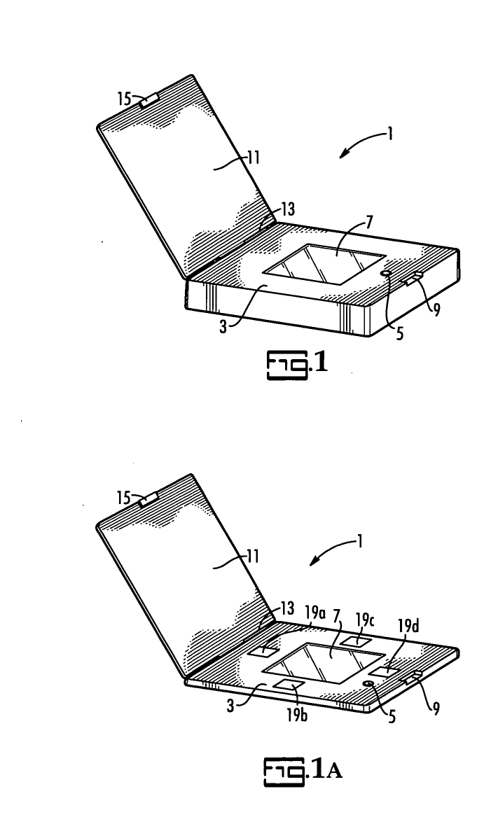

FIG. 1 shows a plan view of the face of the access device with the protective cover opened. As illustrated, the exterior portion 1 includes a housing 3, a light emitting diode 5 which indicates the status, i.e. whether the device is asleep or awake. Additional LED's also may indicate whether the doors are locked or unlocked, and may also include information regarding the status of the alarm system. One light is illustrated; more than one light may be used.

Central to the concept and central in the illustrated embodiment is a fingerprint sensor/reader 7. The design and operation of the sensor is not the subject matter of this invention and commercially available biometric readers are suitable.

Illustrated as element 9 is a wakeup switch for the system. In the preferred embodiment this may be a reed switch mounted under a surface of the housing. Alternatively, other conventional switching means such as heat detectors, spring loaded buttons and proximity switches may be used.

In the embodiment shown, a protective cover 11 mounted to housing 3 using a hinge 13. The cover carries a magnet 15 to activate and deactivate the reed switch.

Alternatively, the outside part of the device, including the fingerprint sensor, may be that as shown in FIG. 1A. Membrane type buttons 19a, 19b, 19c, 19d . . . 19n may surround the sensor 7. The buttons 19 may be used to wake-up the system and/or select a particular function such as “open door.” The element 9 may not be functional in such an embodiment and may be deleted if the hinge 13 is spring-loaded.

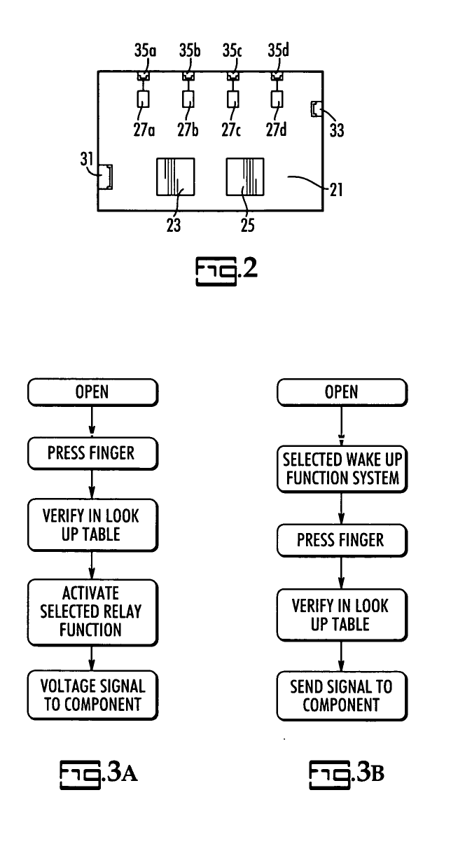

FIG. 2 is a plan view of a circuit board according to this invention showing functional components. A circuit board 21 has mounted thereon a chip 23, optionally a second chip 25, and switching devices 27a, 27b, 27c . . . 27n. The switching device may be a relay or a solid state switch. A connector 31 provides for connection to one or more external access devices. Preferably, it is an RJ45 for a tape connector but is not so limited and may represent a multiplicity of connections for multiple individual leads. A second connector 33 is provided for connection to a power supply such as a fuse panel to provide a source of voltage equivalent to that used to actuate door-opening solenoids. Alternatively, power may be sourced from the vehicle power supply through a rechargeable storage battery. Power for the circuit board may originate from one of these sources and be stepped down through a transformer. The primary chip 23 contains the look-up table of fingerprint data for enrolled users. Placement in this location may be more convenient when multiple sensors are used when a single fingerprint sensor is used. Otherwise, chip 23 contains enrollment information and may be moved in the housing for the fingerprint sensor. The chip may also include functional operations to activate switching device 27a, 27b, 27c . . . 27n. More conveniently, after the enrolment has been validated by chip 23, the operation would be controlled by a second chip 25. The latter would direct the appropriate signal to switching devices 27a . . . 27n to connect power from connector 33 to appropriate output ports (plug connects) 35a, 35b, 35c, 35d . . . 35n to energize the desired operational function. An additional plug connector may be used for enrolling.

The plug connectors in other embodiments would have two or more circuits. The first circuit controls an operational function such as unlocking a door. The second circuit controls an alarm function, a starter interlock function and/or any other function controlled by the OEM vehicle electronics system. For example, when a door is unlocked, the solenoid for the motion of the lock would be energized and, simultaneously, the alarm system would be deactivated. When the door is locked using the fingerprint system on the OEM system, use of the fingerprint system without the OEM key may be used to disconnect the starter when the OEM system does not, and the alarm is reset. In a third embodiment, certain functional activities such as opening the driver's side door would also be integrated into an interlock starter. Conversely, the interlock may be on a separate command. An emergency override of the interlock may be provided at a concealed location.

Many new vehicles are equipped with a combination of a cellular telephone and global positioning satellite (GPS) locator. Such a system may be integrated into this system to unlock the doors in the event of an accident, and disable the ignition in addition to automatically dialing an emergency telephone number.

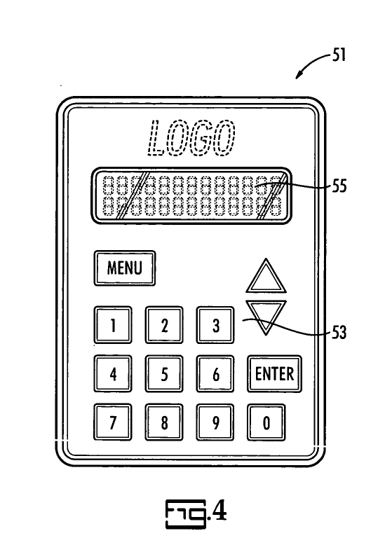

FIG. 3A shows a sequence of events to enter a locked car. The protective cover is opened, triggering the reed switch, awakening the circuit board and indicating that the system is activated by the glow of the LED. In the preferred embodiment, this action also starts a clock. If no enrolled print is received within a specified period of time, the system shuts down. This is both a power saver function and a deterrent to the uninitiated. When a finger is placed upon the fingerprint sensor, the print is read and the characteristics sent to the chip 23 for verification of enrollment and function. When valid, a signal is sent from chip 23 to switching devices 27a . . . 27n or to chip 25 to activate the appropriate relay. Actuation of the appropriate switching device sends voltage (e.g. 12 v) to the appropriate solenoid or circuit board for a sufficient time to effect the intended result (e.g. disengage alarm and unlock door).

When the embodiment of FIG. 1A is employed, the order would be changed to that shown in FIG. 3B to require the selection of a desired function using a button 19 which would likewise constitute the wake-up call. Alternatively, the placement of a finger on the sensor pad may be used to wake-up the device.

When exiting the vehicle, the operation would perform the same operations, i.e. open cover, place appropriate finger on fingerprint sensor, and the device would perform the same function except that the relay would be deactivated or activate to a different plug pin, as required by the on-board system design, to lock the doors and activate the alarm etc.

Because the fingerprint sensor system works through the existing keyless entry system, the access and locking can be performed by either modality and one may enter the vehicle using the fingerprint system, and leave using the acoustic keyless system.

Many cars have many users, especially fleet vehicles used by the Federal, State and Local Governments. Police vehicles, in particular, may be driven by two or more persons each day and may be used by an entire police force over the course of the lifetime of the vehicle. For such an application, individual enrollment on each car is at best time consuming. An alternative is to provide a common “fingerprint” in the form of a card such as a “smart card” which can be read by a reader mounted inside the vehicle, typically on the dashboard. The individual users are enrolled electronically at a central location using their natural fingerprint and given the “shuttle” card which provides access to the fleet of vehicles and may or may not include an identifier of the user (which may be recorded upon each use in chip 23 for recall if an when needed). When the vehicle is reassigned to a different cohort of users or sold, the access code may be changed or deleted on each vehicle.

One advantage in using a chip on a shuttle card instead of an actual fingerprint sensor is that enrollment may be simplified. Enrolling can take place at the dash and only 4 wires are required which allows greater separation of components. As shown in FIG. 4, the sensor 51 may be located at a convenient place. The enrolling chip may be located at a second location and the black box containing the switches may be placed at a third locations.

The above-described scenario is also applicable to chips which may be personally enrolled in place of an electronic fingerprint sensor. An RF chip sensor (smart card reader) may be affixed to the dashboard or any other surface within the vehicle where it can be secured and used to read a card including a personal chip.

Certain available optical fingerprint sensors can read through glass, such as a windscreen, and may be used with this device provided that an alternative such as a proxy switch or a button is used in place of the reed switch and magnet described above to wake-up the system. For some applications, especially non-automotive, it may be desired to incorporate the entire black box into the base of the fingerprint sensor. This requires that the box and the connection to it be waterproof, but does not change the device otherwise.

The system of this invention is intended to include means for emergency restart of a vehicle in the event that the main battery fails, such as by a drain being left operative when the vehicle is shut down. A rechargeable, preferably alkaline, battery such as may be used to operate the security system that is regularly kept fully charged by a charger pulling voltage from the main battery. In the event that the main battery becomes discharged, the rechargeable alkaline battery takes over and may be used to provide sufficient “surface charge” to the main battery to start the vehicle, after 15 to 20 minutes.

The wakeup call system protects the alkaline battery. It also provides a second line of security if the main battery fails. The wakeup call system allows the device to remain functional for more than one year when not in use and allows the alkaline battery to charge the main battery for up to one year.

FIG. 4 illustrates an enroller for the system which is a preferred alternative. The enroller 51 has a key pad 53 and a display window 53. The enroller connects to the system such as at element 31 or to a pigtail attached thereto. Power is derived from the system. On a new installation the enroller detects that no security code has been entered and prompts the user to enter a multi-digit code. The code is memorized by all devices on the bus and serves as a password which authorizes any subsequent transactions. One subsequent uses, the enroller can power up prompts that are used to enter the code. Enrolling of prints follows the process described previously. The enroller may be modified to encode a memory code for a smart card such as that discussed above for flat operations.

The invention which has been described and illustrated in detail in the foregoing description is the preferred embodiment. All changes and modifications apparent to a person of ordinary skill in the art come within the spirit of the invention and are included within the scope of the invention as more particularly described in the following claims.

1. A device to provide fingerprint access to a vehicle having electrically or electronically activated access control system comprising:
a housing including an electronic fingerprint sensor;
a means for connecting the device to a power source;
a chip for storing information identifying an electronic fingerprint;
means to activate at least one device whereby activation of said device allows access control.

2. A device according to claim 1 further providing means to deactivate at least one device whereby deactivation of said device denies access.

3. A device according to claim 1 wherein said electronic fingerprint is an electronic image of a human fingerprint.

4. A device according to claim 1 wherein said electronic fingerprint is an electronic code which is unique to an individual.

5. A device according to claim 1 wherein said means for activating at least one device includes at least one circuit board and at least one switching device.

6. A device according to claim 5 wherein said switching device is a relay.

7. A device according to claim 1 wherein said housing is mounted on the external surface of a vehicle.

8. A device according to claim 1 wherein said housing is mounted on the internal surface of a vehicle, said surface being transparent to said sensor.

9. A device according to claim 1 wherein more than one sensor is used on or at an

10. A device according to claim 1 wherein access control is selected from the group consisting of door locks, trunk locks, alarms, ignition systems, fuel pumps and starter motors.

11. A device according to claim 1 wherein stored information is obtained using both an electronic fingerprint sensor and an external device.

12. A device according to claim 11 wherein said external device is a PC or a PDA.

13. A device according to claim 12 which is password protected.

14. A device for preventing the theft of a motorized vehicle separately from any keyed or acoustical entry system comprising:
an external housing for an electronic fingerprint sensor having means to verify enrollment;
means for connecting the device to a power source;
means to activate at least one of the group consisting of door locks, ignition systems, fuel pumps and starter motors;
whereby said vehicle cannot be accessed unless an enrolled fingerprint is read by said fingerprint sensor.

15. A device according to claim 14 wherein said electronic fingerprint is an electronic pattern characteristic of an individual.

16. A device according to claim 15 wherein said electronic pattern is stored on a chip.

17. A device according to claim 14 further comprising a rechargeable backup battery of sufficient capacity to enable a vehicle to start when the main battery has been discharged.

18. A device according to claim 14 further comprising a smart card reader mounted on or in the vehicle to provide means for quick download of fingerprint images.
